(19) United States
(12) Patent Application Publication
(10) Pub. No.: US 2026/0284997 A1
(43) Pub. Date: Sep. 24, 2026

(54) PRESS MOLDING METHOD INCLUDING A COLLAPSIBLE STAMP MEMBER FOR PRODUCING A CUP SHAPED FIBER PRODUCT

(71) Applicant: Blue Ocean Closures AB, Karlstad (SE)

(72) Inventors: Lars Sandberg, Hammarö (SE); Staffan Andersson, Norrköping (SE)

(73) Assignee: Blue Ocean Closures AB, Karlstad (SE)

(21) Appl. No.: 19/472,307

(22) PCT Filed: Apr. 17, 2024
(86) PCT No.: PCT/EP2024/060350

§ 371 Date: Oct. 3, 2025

(30) Foreign Application Priority Data
Apr. 17, 2023 (SE) 2350453-3

(51) Int. Cl. B31B 50/59; B31B 120/00

(52) U.S. Cl. CPC B31B 50/592; B31B 2120/00

(57) ABSTRACT

A press molding method produces a cup-shaped fiber product, at high pressure of at least 50 bar and high temperature of above 100° C., using a press pad device and a stamp device, wherein a blank having a moisture content not exceeding 20% is introduced into a cavity of said press pad device by means of said stamp device. A collapsible stamp device is used in the method, where the device has at least partially a collapsible core member adjustable using an actuator between a minimal diameter and a maximal diameter, respectively.

### TECHNICAL FIELD

This invention relates to a press molding method of a cup shaped fiber product,

### TECHNICAL BACKGROUND

A cup shaped fiber product can be made by pressing a web or a sheet of fibers. Typically, a combination of natural fibers (e.g. wood pulp fibers), synthetic fibers (e.g. polyoliphene based fibers) and other additives such as binder or dye. In many applications it is preferred that such a web essentially merely comprises of natural fiber, with or without additives. Typical process conditions are 150-250 C and pressures 100-10000 bar (200-2000 Bar). Moisture content may typically be less than 20%.

Fiber products can be in the form of a hollow product, for example a package or a closure (lid, screw cap or similar), but can also be a flat product. Products can be formed from a web of the material and punched/cut in connection with forming, e.g. that have been completely or partially separated from the web to allow deeper shaping. This exposure is typically done by cutting the material into a shape that is adapted to the final shape, i.e. making a blank. Typically, for example, a roundel is cut to form a round package.

The press molding typically takes place with two tools where both the outer tool pad and the inner tool (stamp) can consist of several parts to enable discharge of the finished product. Typically, the pad opens while the stamp collapses. Exemplary known collapsible cores are known from GB 607700, GB 676,356, US 3618170 and U.S. Pat. No. 3,613,605, wherein GB 607700 is the only one for producing fiber products and relates to use of with a binder pretreated paper blanks which blanks are pre-sized to enable sliding the blank into a complex tool pad to produce screw caps. GB 676,356 relates to moulding of hollow concrete and similar articles and U.S. Pat. Nos. 3,613,605 and 3,618,170 relate to an expandable core assemblies for use in an injection molding operation designed to produce hollow plastic articles. The piston, parts of the piston or parts of the pad can also be made of a compressible material which enables greater vertical compressive forces, typically against the sides of the cavity, by the tool material being reshaped during the compression. When a cup shaped product is formed, the stamp may in a first step be used to move the blank into the pad before the actual pressing is achieved. In some applications a collapsible core is used Known methods do not always provide for a good quality as desired and accordingly there exist a need of improvement.

### SUMMARY OF THE INVENTION

It is an object of the invention to eliminate or at least minimize the disadvantage mentioned above, which is a achieve by a method as defined in claim 1.

Thanks to the invention it may be achieved a better shaped product in that the quality of the product may be higher. Furthermore, the design of the press mould may provide less costly manufacturing than generally known designs using collapsible cores.

### DESCRIPTION OF FIGURES

In the following, the invention will be described with reference to schematic figures presenting the basics of the invention, in which:

FIGS. 1-3 shows schematic side views of an adjustable/collapsible core presenting the basic principle according to the invention, in different subsequent positions when producing a shaped fibre product,

FIG. 4 shows an end view of an exemplary adjustable/collapsible, illustrating basic principles of an exemplary adjustment mechanism,

FIGS. 5, 6, 7 show side views in perspective of a modification according to the basic inventive concept, wherein different stages of producing a fiber product is shown.

### DETAILED DESCRIPTION

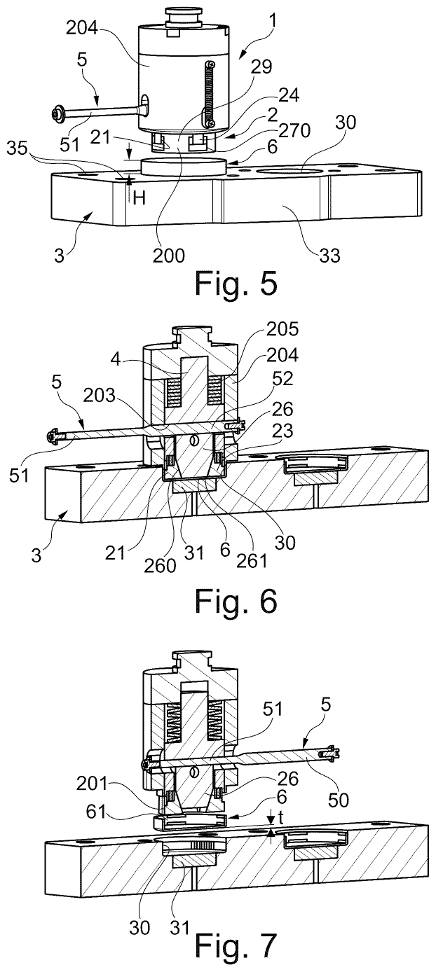

As is well known to the skilled person within the field a fiber press mould comprises a press pad device 3 (see FIGS. 5-7) and a stamp device 1, for forming a fiber product 6 (see FIGS. 5-7), wherein the press pad device 3 for forming a cup shaped fiber product comprises a body, having a cavity enabling pressing of that cup shaped fiber product.

Preferably the cavity 30 (see FIGS. 5-7) is provided in a solid body 33 of the pad device 3, which may provide a reliable and cost-efficient solution. The stamp device 1 comprises a stamp body 2 adapted to fit into the cavity of the pad member such that a gap for the cup shaped fiber product is formed between the outer surfaces 200 of the stamp body 2 and the facing surfaces of the cavity, whereby a desired thickness of the walls of the fiber product may be achieved. The fiber product is made by use of an adapted blank having a moisture content below 20%. High temperature is used during production and high pressure is applied by means of the stamp 2 to form the blank into a shaped fiber product. The molding temperature may be in the range of 150-250° C. and the applied pressure by the stamps is at least 200 bar, wherein at least one of the stamp member or the pad member has the said temperature. Thanks to the high pressure and high temperature a significant increase of density of the blank transformed into the product 6 may be achieved, preferably an increase of density is achieved of at least 1000 kg/m3, preferably in the range of 1100 to 1300 kg/m3 . The blank may have a grammage within the range of 200-20000 g/m2, preferably above 500 g/m2 .

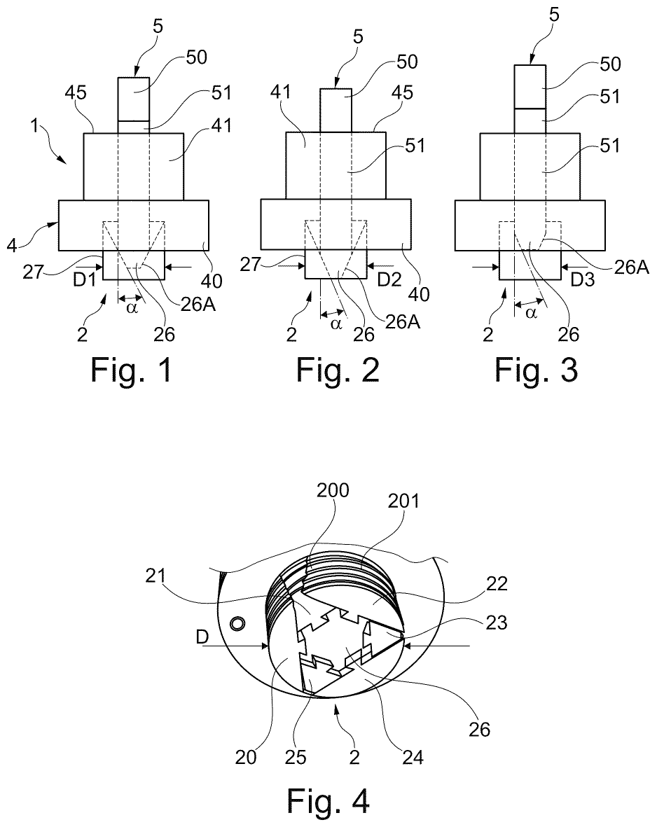

In FIGS. 1, 2 and 3 there are schematically shown an exemplary collapsible stamp device 1 in different positions. Basically, the collapsible stamp device 1 comprises a collapsible core member 2 having fiber facing surfaces 200. Preferably said fiber facing surfaces 200 have irregularities 201 e.g. in the form of protruding spirals for producing a cap with threads. The collapsible stamp device 1 may comprise an outer housing (not shown) and slideably arranged therein a support body 4. Through the support body 4 centrally therein there is arranged a passage for an actuator 5. The actuator 5 may be adjusted into different positions to arrange for varying diameters D1, D2, D3 of the core member 2. The actuator 5 may comprise a manoeuvring member 50 and a rod member 51. The manoeuvring member 50 is arranged at one end of the rod 51 and at the other end of the rod member 51 there is attached an adjusting member 26. As shown the adjusting member has interacting surfaces arranged at an angle a which preferably is in the range of 15-40°, more preferred at least 20° (see FIGS. 3-5). The adjusting member 26 interacts with parts of the core member 2 to enable contraction and expansion of the diameter D of the core member 2, by means of longitudinal displacement between the parts of the core member 2 and the adjusting member 26. The displacement of actuator 5 may be achieved in different ways, e.g. by rotation and use of interacting threads or merely by a sliding movement. The angle a will control how much the diameter D id adjusted in relation to the distance of movement of the actuator 5.

The exemplified support body 4 comprises a lower annular part 40 and an upper annular part 41, wherein preferably the lower annular part 40 having a larger diameter than the upper part 41, such that members of an outer housing (not shown) may protrude through guiding passages in the lower annular part 40 of the support body 4.

In FIGS. 1, 2 and 3 there are shown schematic side views of a collapsible stamp 1 representing in a general manner the important basic principle according to the invention in that it demonstrates at least three different modes that are used when producing a shaped fibre product according to the method of the invention, without any limitation to how the adjustment of the diameter of the collapsible core member 2 is achieved, since as the skilled person within the field knows there exist a plurality of known actuator mechanisms that may be used to achieve adjustability of the diameter. Preferably the actuator at a distal end has a manoeuvring member 50 enabling attachment/connection to some kind of actuating device (not shown) for movement of the actuator 5.

In FIG. 1 the collapsible stamp device is shown in a first position for use at the initiating phase of producing shaped fibre molding products, e.g. having collapsible core member 2 with fibre facing surfaces 200 to produce a cap with threads. In this position the diameter D1 is smaller than the size of the diameter D2 in its most expanded position, which is shown in FIG. 2. Accordingly, in FIG. 1 the actuator 5 has been moved a small distance away from contact with the upper part 45 of the support body 4, which in turn moves the adjusting member 26 and thereby makes the diameter D1 of the collapsible core member 2 smaller than in FIG. 2.

In FIG. 2 it is shown that the actuator 5 is in its innermost position, i.e. having the manoeuvring member 50 close to the upper side 45 of the support body 4 and as a consequence the diameter D2, shown in FIG. 2 presents the maximum diameter possible. Hence, in FIG. 2 it is shown a position where the actuator 5 has been pushed in as long as possible, e.g. the manoeuvring member 50 having a stop member (not shown) pressed against the upper end 45 of the support body 4 and as a consequence the adjustable member 26 will then be in its outermost position and therefore have expanded the collapsible core member 2 into its largest diameter D2.

In FIG. 3 it is shown a position where the actuator 5 has been pulled out as long as possible having the manoeuvring member 50 far away from the upper end 45 of the support body 4 and as a consequence the adjustable member 26 will then be in its innermost position and therefore have contracted the collapsible core member 2 into its smallest diameter D3. In this position the collapsible core member 2 will now longer be in contact with the shaped fiber product. Hence the shaped fiber product may be taken off from the collapsible core member 2. To assist in taking the shaped product off from the collapsible core member 2 the inner body 4 may be slid upwards within a housing (not shown) to enable a lower annular part of the housing to push the product away from the collapsible core member 2.

In FIG. 4 it is shown a more detailed view of an exemplary embodiment of a core member 2 of an adjustable collapsible stamp 1. It is shown that the adjustable member 26 which is attached to the rod 51, is positioned in an intermediate position such that the diameter D of the collapsible core member 2 is smaller than the maximum diameter D2. The design of this exemplary, collapsible core comprises three intermediate bodies 21, 23, 25 and three outer bodies 20, 22, 24, together forming the outer surface 200 that will form the inner surface of the pressed product. The different parts are attached to each other by dove tail fittings. Also, the adjustable member 26 is arranged with dove tail fittings. The intermediate bodies 21, 23, 25 have a dimension that decrease adjacent the end of the collapsible core member 2. Accordingly, each intermediate member 21, 23, 25 have the dove tail part arranged further away from the outer surface near that end. As a consequence, when moving the adjustable member 26 away from the end the dove tail fittings thereof, it will push each of the intermediate bodies 21, 23, 25 away from the centre and thereby the dove tail fittings of the intermediate bodies will also move the outer bodies 20, 22, 24 away from the centre, i.e. causing an expanded diameter.

In FIGS. 1, 2 and 3 there are shown schematic side views of a collapsible stamp 1 in three different modes when using the stamp 1 to produce a shaped fiber product. First, as shown in FIG. 1 the diameter D1 is adjusted to be in between a maximum diameter D2 and a minimal diameter D3. Preferably D1 is in a range of about 0,6-10,0 mm, smaller than said maximal diameter D2, more preferred in the range of 1-6 mm smaller than said maximal diameter D2. This mode of the collapsible core member 2 is used to introduce a blank (not shown) into the press pad device (not shown) by using the collapsible core member 2 to push the blank into the press pad device in an optimized manner. Once in place within the press pad device the collapsible core member 2 is expanded by actuating the actuator 5 such that the maximum diameter D2 of the collapsible core member 2 is achieved. In this state the actual pressing is performed, i.e. applying high pressure and high temperature (se above) resulting in a cup shaped fibre product. Thereafter pressure is released and the collapsible core member 2 with the shaped fibre product removed from the press pad device. In a subsequent step the actuator is moved such that a smallest diameter D3 of the collapsible core member 2 is achieved, where after the shaped fibre product may be released from the collapsible core member 2.

Thanks to the invention a great flexibility is provided regarding optimization to achieve high quality by enabling optimized adjustment of the cross-sectional dimension, e.g. diameter, of the collapsible core member 2 when introducing the blank into the press pad device, e.g. to achieve a more uniform distribution of fibres in all parts of the shaped fibre product.

As is evident for the skilled person the maximal diameter D2 is above defined by the physical limitations provided by means of the inwardly facing walls of the pad device during the pressing operation, wherein the maximal diameter D2 of the collapsible core member 2 may correspond to the limitation of the inwardly facing walls of the pad device. However, in an alternate embodiment the collapsible stamp device 1 may be arranged to enable expansion thereof to an excess diameter D2+exceeding the maximal diameter D2 when said collapsible stamp device 1 is expanded outside of said pad device, i.e. not being limited by the inwardly facing walls of the pad device. By this design it is facilitated to apply extra pressure by means of the actuator 5 of the collapsible stamp device 1 during the pressing operation, i.e. applying extra lateral pressure. Preferably the excess diameter D 2+is in the range of 102%-105% of said maximal diameter D2.

The use of the collapsible core is especially advantageous when the shaped product has threads, under cut, snap in members, or any other kind of member/detail of the fiber product that causes nonuniformity of an inner surface of the product, e.g. substantially vertical surface in contact with the collapsible core member 2.

Preferably the collapsible core member 2 includes some kind of passages, e.g. perforations, to enable evacuation of steam that may be produced during the pressing operation. In order to minimize the possibility of having fibers clogging passages gaps/opening should preferably not exceed 0,2 mm. fibers Further, it is beneficial to arrange the collapsible stamp member with back flush ability, to arrange for the possibility to clean passages from debris.

Preferably the material in the body is such that it may withstand high pressure and having good heat conductivity. The body 2 shall at least be able to retain it shape at a pressure of 50 bars, preferably within the range of 150 to 1000 bar. Different production methods are foreseen, e.g. traditional molding and/or forging or 3D-printing.

In FIGS. 5, 6 and 7 there is shown a modification to efficiently produce a cup shaped fiber product 6, having threads 61, wherein FIG. 5 shows a first stage, wherein the stamp device 1 has a partly collapsible core 2 that is in an expanded state ready to press a fiber blank 6 into a cavity 30 of the press pad 3, FIG. 6 shows a cross-sectional view at a stage where the stamp device 1 has completed the pressing operation and FIG. 7 shows a final stage where the stamp device 1 has been taken out from the cavity 30 of the press pad 3 and the product 6, in the form of a screw cap, loosened from the stamp device 1.

In the following merely essential basic features of the invention will be described, since as is evident for the skilled person in the field many of the shown details can be varied to still fulfil the basic desired function.

In FIG. 5 there is shown a stamp device 1 having the core 2 positioned at a level above the press pad 3, and having a fiber blank 6 positioned centrally in relation to the cavity 30 in the press pad 3. It is shown that the fiber blank 6 has a relatively large thickness T, providing sufficient fiber material for shaping a 3D-product in accordance with the invention. The thickness of the walls of the final product 6 will be substantially much smaller than the original thickness T of the blank 6. Normally t will be less than 0,6 T, more preferred 0,5 T or less.

It is shown that the stamp core 2 has a central part 26 with a tapered sides 260 having a (preferably flat) front end 261. The tapered sides 260 of the central part 26 are in contact with a plurality (preferably at least three, more preferred four) radially movable parts 21-24 of a partly collapsible core 2, enabling expansion of the movable parts to shape the fiber product. It is shown that the movable parts 21-24 are positioned in level with a fixed stamp pressing member 29 that has passages 270 enabling the movable parts 21-24 to move radially between an inner position and an outer position. Further, it is shown that the movable parts 21-24 have protrusions 201 forming parts of threads 61 in a shaped screw cap 6 (see FIG. 7). At the outer position the basic outer surface of the movable members 21-24 will preferably be positioned inside of the outer fiber facing surface 200 of the fixed member 29, preferably such that the outer edge of the protrusions 201 are in level with the outer fiber facing surface 200 of the fixed member 29. Hence, when the movable parts are pressed outwardly the protruding threads 61 will be formed inside of the outer circular surface 200 of the fixed part 29.

Further, as is shown there is an actuator 5 that may actuate the movable parts 21-24 to either be positioned in an outer position or an inner position. The actuator is in the form of a rod having one portion 51 with a small diameter and second portion 52 having a large diameter, e.g. twice larger than the small diameter. The actuator 5 fits into a transversal passage 203 through the stamp device 2. The transversal passage 203 partly passes through an outer cylindrical housing 204 and also between the central part 26 and a support body 4. The support body 4 is integral with the fixed core part 29 and slidably arranged within the cylindrical housing 204. The actuator 5 when actively positioned with the large diameter portion 52 will press the central part 26 to move downwards such that the movable members 21-24 by means of interacting with the tapered sides 260 will be pushed out into the outmost position, as is shown in FIGS. 5 and 6.

FIG. 6 represents the first stages of the actual pressing of a screw cap 6 in accordance with the invention. This is achieved by allowing the stamp device 2 to move downwards into the cavity 30 of press pad 3 and simultaneously move the blank 6 into the cavity 30 within the press pad 3. It is to be noted that the press pad preferably comprises a body 33 that is solid and that the cavity 30 within the press pad 3 forms a fixed cavity within the solid body 33 of the press pad 3, which solid body is intended to be fixed during the pressing operation, e.g. fixing holes 35 for screws (not shown). Furthermore, it is shown that inserts 31 may preferably be used forming a part of the bottom of the cavity 30 which insert 31 may provide an exchangeable outer surface of a produced screw cap, e.g. to present different trade marks on top of the screw cap 6.

When the stamp 2 has been firmly pressed into the cavity 30, compressing a spring package 205, with a high pressure, at least 50 bar, and a high temperature, at least 150° C. (as already mentioned), the fibers of the blank 6 will be compressed and form an integrated stable fiber network forming a fiber product 6, e.g. a screw cap, with high strength, whereby the density of the produced fiber product is significantly increased and the thickness t of the produced fiber product is substantially less than the original thickness T of the fiber blank thanks to the integrating effect of applying high pressure and high temperature during the pressing stage.

Now when the product has been pressed into its intended shape the stamp 2 may be removed out from the cavity 30 of the press pad 3. In a subsequent stage, the actuator 5 is then moved transversally, to have the portion 51 with a smaller diameter in operation, whereby the movable members will move inwardly, such that the protruding thread portions 271 will get out of contact with the threads 61 of the screw cap 6, and thereby arrange for release of the screw cap.

Preferably the fiber material in the fiber product 6 is in the form of natural fibers from wood. Further, the amount of water in pre-cut blank (e.g. roundel) prior to pressing shall not exceed 20% the weight of fiber.

1. Press molding method of a cup shaped fiber product, at high pressure of at least 50 bar and high temperature of above 100° C., by means of a press pad device and a stamp device, wherein a blank having a moisture content not exceeding 20% is introduced into a cavity of said press pad device by means of said stamp device, characterized in using wherein the method uses a collapsible stamp device having an at least partially collapsible core member adjustable by means of an actuator between a minimal diameter and a maximal diameter, respectively.

2. Press molding method according to claim 1, wherein said press pad device comprises a solid body arranged with fixation means and that said cavity is arranged in said solid body

3. Press molding method according to claim 1, wherein said actuator is moved transversally in relation to the direction of movement of said stamp device.

4. Press molding method according to claim 3, wherein said actuator is in the form of a rod device having a first portion with a first maximum cross-sectional measurement and a second portion with a second maximum cross-sectional measurement larger than said first maximum cross-sectional measurement of said first portion.

5. Press molding method according to claim 1, wherein said collapsible core member comprises one fixed part having radially extending passages and includes a plurality of radially movable members arranged to be movable between said minimal diameter and a maximal diameter in said passages, respectively.

6. Press molding method according to claim 3, wherein said movable members are arranged with protruding ridges in the form of parts of threads being imprinted on an inner surface of said cup shaped fiber product.

7. Press molding method according to claim 1, wherein said collapsible core member is adjusted to an intermediate diameter in between said maximal diameter and said minimal diameter in connection with introduction of said blank into said press pad device and that said collapsible stamp device in connection with the pressing operation is adjusted to said maximal diameter, wherein preferably said intermediate diameter is adjusted to be in the range of 0.6-10.0 mm, smaller than said maximal diameter, more preferable in the range of 1-6 mm smaller than said maximal diameter.

8. Press molding method according to claim 7, wherein said maximal diameter is arranged to be limited by means of the inwardly facing walls of said pad device and wherein said collapsible stamp device is arranged to enable expansion thereof to an excess diameter exceeding said maximal diameter when said collapsible stamp device is expanded outside of said pad device, wherein preferably said excess diameter is in the range of 102%-105% of said maximal diameter.

9. Press molding method according to claim 8, wherein said collapsible stamp device in connection with said pressing operation is used to apply a lateral excess pressure.

10. Press molding method according to claim 1, wherein said collapsible core member includes some kind of passages enabling evacuation of steam during the pressing operation, wherein preferably a maximum cross-sectional size of an outwardly exposed opening of said passage/s is 0,2 mm or less.

11. Press molding method according to claim 1, wherein the blank consists comprises at least mainly of natural fibers.

12. Press molding method according to claim 1, wherein during the pressing operation the temperature is 150-250° C. of at least one of said stamp and/or pad member and the pressure is at least 100 bar.

13. A fiber press mould, comprising a press pad device and a stamp device, wherein said press pad device and said stamp device are arranged to facilitate production of cup shaped fiber products at a pressure above 50 bar and above 150° C., characterized wherein said stamp device has a collapsible core member and actuator, wherein said actuator is arranged to enable adjustment between a minimal diameter and a maximal diameter, respectively.

14. A fiber press mould, according to claim 13, wherein said a collapsible core member includes fiber facing surfaces including irregularities arranged to shape protruding members on inner surface/s of the cup shaped product.

15. The press moulding method of claim 11, wherein the natural fibers are made from wood.

16. The press moulding of claim 12, wherein the pressure is at least 150 bar.
